(19) United States
(12) Patent Application Publication
(10) Pub. No.: US 2019/0145689 A1
(43) Pub. Date: May 16, 2019

(54) CRYOGENIC COOLING SYSTEMS AND METHODS OF CONTROLLING PRODUCT TEMPERATURES DURING DELIVERY

(71) Applicant: Walmart Apollo, LLC, Bentonville, AR (US)

(72) Inventors: David C. Winkle, Bella Vista, AR (US); Brian G. McHale, Chadderton Oldham (GB); Bruce W. Wilkinson, Rogers, AR (US); Donald R. High, Noel, MO (US); Todd D. Mattingly, Bentonville, AR (US)

(21) Appl. No.: 16/301,999

(22) PCT Filed: May 18, 2017
(86) PCT No.: PCT/US2017/033236

§ 371 Date: Nov. 15, 2018

Related U.S. Application Data
(60) Provisional application No. 62/338,231, filed on May 18, 2016.

(51) Int. Cl. F25D 3/10; B60P 3/20; F25D 29/00

(52) U.S. Cl. CPC F25D 3/105; F25D 2700/16; F25D 29/001; B60P 3/20

(57) ABSTRACT

In some embodiments, systems and methods are provided that limit the change in temperature and/or control a temperature of a product during delivery. Some embodiments provide systems to limit temperature changes, comprising: a product cooling system comprising: a product cavity that supports a product, wherein the product cooling system is separate from and removable from the delivery vehicle and comprises an insulation about the product cavity; a cryogenic substance dispensing system that injects a cryogenic substance into the product cavity; and a temperature sensor; and a temperature control circuit coupled with the temperature sensor and the cryogenic substance dispensing system, wherein the temperature control circuit is configured to determine that a temperature of the product is greater than a threshold, and autonomously activate the cryogenic substance dispensing system to release the cryogenic substance.

### CROSS-REFERENCE TO RELATED APPLICATION

This application claims the benefit of U.S. Provisional Application No. 62/338,231, filed May 18, 2016, which is incorporated herein by reference in its entirety.

### TECHNICAL FIELD

This invention relates generally to product temperature control systems.

### BACKGROUND

In a modern retail environment, there is a need to improve the customer service and/or convenience for the customer. One aspect of customer service is the delivery of products. There are numerous ways to delivery products to customers. Getting the product to a delivery location, however, can adversely affect the product, can cause undesirable delays, can add cost and reduce revenue.

### BRIEF DESCRIPTION OF THE DRAWINGS

Disclosed herein are embodiments of systems, apparatuses and methods pertaining to product temperature control systems. This description includes drawings, wherein:

FIG. 1 illustrates a simplified block diagram of an exemplary product delivery coordinating system configured to coordinate and/or schedule delivery of products while limiting temperature changes and/or maintaining temperatures of one or more products while transported to one or more delivery locations, in accordance with some embodiments.

FIG. 2 illustrates an exemplary system for use in implementing methods, techniques, devices, apparatuses, systems, servers, sources and the like in limiting temperature changes of a product during transit, in accordance with some embodiments.

FIG. 3 illustrates a simplified cross-sectional view of an exemplary cryogenic substance cooling system, in accordance with some embodiments.

FIG. 4 illustrates a simplified flow diagram of an exemplary process of limiting temperature changes of a product during transit, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to limit changes in temperature of one or more products being transported to a delivery location. By limiting changes of temperature, products can be kept below threshold temperatures, maintain a freshness of products, and other such benefits. In some embodiments, the system identifies various delivery parameters in selecting a cooling system, from multiple different available cooling systems, that is to be used in limiting temperature changes and/or maintaining temperatures of one or more products while the one or more products are transported to one or more delivery locations. The cooling systems can be implemented to provide temperature control of one or more products, typically a limited number of products, and without having to control the temperature of an entire delivery vehicle or large compartment of a delivery vehicle. Accordingly, the multiple product cooling systems can limit temperature variations and/or control temperatures specific to individual or limited numbers of products. Further, in some embodiments the cooling systems are configured to have a relatively small volume. In some implementations, the product temperature control systems (e.g., product cooling systems) can provide individual temperature control for a single product. Such individual temperature control allows individual products to be transported by some delivery methods while still maintaining desired temperature thresholds, and/or can transport one or more products that are to be maintained at different desired temperatures along with other products that do not require temperature control by the same delivery vehicle.

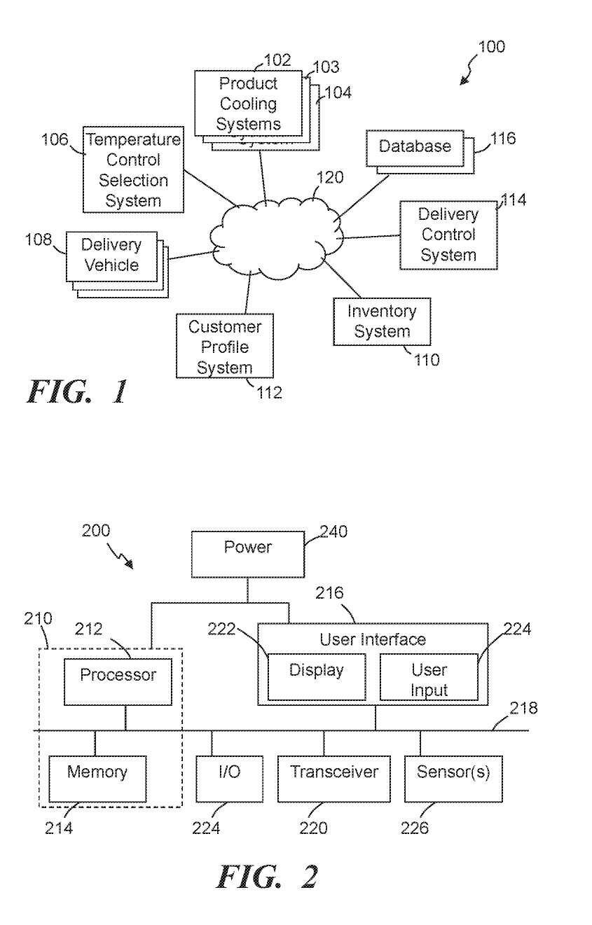

FIG. 1 illustrates a simplified block diagram of an exemplary product delivery coordinating system 100 that is configured to coordinate and/or schedule delivery of products while limiting temperature changes and/or maintaining temperatures of one or more products while transported to one or more delivery locations, in accordance with some embodiments. The system 100 includes multiple different types of product cooling systems 102-104 and/or product heating systems, a temperature control selection system 106, and multiple different types of delivery vehicles 108. Some embodiments further include one or more inventory systems 110 associated with one or more retail facilities, customer profile system 112, delivery control system 114, and one or more databases 116 (e.g., one or more customer databases, inventory databases, product databases, route parameter databases, etc.). One or more computer and/or communication networks 120 establish communication connections between two or more of the components of the system 100 and allow communications and/or data transmissions between two or more of the components of the system 100. In some embodiments, the delivery coordinating system 100 is associated with one or more retail facilities from which products can be purchased and/or that coordinates delivery of those products. The shopping facility may, in some instances, be a retail sales facility, a fulfillment center, a distribution center, or other type of facility in which products are sold and/or distributed to customers. The facility may be any size or format, and may include products from one or more merchants. For example, a facility may be a single store operated by one merchant, a chain of two or more stores operated by one entity, or may be a collection of stores covering multiple merchants.

The temperature control selection system 106 utilizes product parameters and delivery parameters in evaluating which product cooling system and/or delivery vehicle are to be employed in transporting one or more products to one or more delivery locations. Typically, the temperature control selection system identifies products that have one or more temperature thresholds that are to be maintained and/or not to be exceeded. For example, a product may have one or more of a desired storage threshold temperature, a desired transport temperature, a regulatory or government specified temperature threshold, other such temperature thresholds, and in some instances a combination of two or more temperature thresholds. Further, some of the temperature thresholds may correspond to time thresholds, where for a particular product it may be desired that the product be maintained below a first temperature threshold, but can exceed the first temperature for less than a threshold duration of time and typically while being maintained under a second temperature threshold. One or more databases may be accessed (e.g., product database, inventory database, regulatory database, etc.) to obtain information about one or more temperature thresholds and/or corresponding duration thresholds, transportation parameters, delivery parameters, customer preferences, and/or other such information, including relevant historic information.

Further, the temperature control selection system typically takes into consideration transportation parameters in selecting a product cooling system 102-104 to be used in transporting one or more products. The transport parameters can include, but are not limited to, expected duration of transport and/or duration of exposure to non-temperature controlled environments (e.g., outside of a freezer or refrigerator), predicted and/or forecasted environmental conditions through which the product(s) is to be transported (e.g., temperatures, humidity, potential wind, precipitation, etc.), and other such information. The transportation parameters may be obtained based on historic data (e.g., historic weather and temperatures, historic traffic patterns, data obtained from similar previous deliveries, etc.) and forecasted data (e.g., forecasted weather, forecasted traffic, etc.), current data, and the like. Further, the transportation parameters may be obtained based on information collected by the retail store or chain of stores, and/or one or more third party sources (e.g., one or more weather services, traffic service, delivery service, etc.). Typically, the transportation parameters can further include and/or consider the time, temperature, mode of transport, type of delivery vehicle, and the like associated with the preparation and/or loading of the product into a cooling system and/or the delivery vehicle, the unloading of the delivery vehicle, and other such factors. The system may take other parameters into consideration including, but not limited to, product parameters (e.g., type of product, size of product, size of multiple products (e.g., sum of volumes and/or volume of strategically arranged products), and the like), customer requests, types of delivery location, whether a temperature control system is available at the delivery location, whether a customer is expected to be available to receive the product(s) at the time of delivery, and other such parameters, and often a combination of two or more of such parameters. For example, the temperature control selection system may identify a relatively short duration delivery by an unmanned aerial vehicle (UAV) of a product with a first threshold temperature below which the product is to be maintained. In sonic implementations, the cryogenic system has a relatively light weight while being able to maintain the first temperature threshold for the expected duration, and select the cryogenic system.

Further, the processes, methods, techniques, circuits, circuitry, systems, devices, functionality, services, servers, sources and the like described herein may be utilized, implemented and/or run on many different types of devices and/or systems. FIG. 2 illustrates an exemplary system 200 that may be used for implementing any of the components, circuits, circuitry, systems, functionality, apparatuses, process, or device of the system 100 of FIG. 1 and/or mentioned above or below, or parts of such circuit, circuitry, functionality, systems, apparatuses, processes, or devices. For example, the system 200 may be used to implement some or all of the product cooling systems 102-104, a temperature control selection system 106, delivery vehicles 108, inventory systems 110, customer profile system 112, delivery control system 114, and/or other such components, circuitry, functionality and/or devices. However, the use of the system 200 or any portion thereof is certainly not required.

By way of example, the system 200 may comprise a control circuit or processor module 212, memory 214, and one or more communication links, paths, buses or the like 218. Some embodiments may include one or more user interfaces 216, and/or one or more internal and/or external power sources or supplies 240. The control circuit 212 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 212 can be part of control circuitry and/or a control system 210, which may be implemented through one or more processors with access to one or more memory 214 that can store code that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 200 may be used to implement one or more of the above or below, or parts of, components, circuits, systems, process and the like. For example, the system may implement the temperature control selection system 106 with the control circuit being a selection system control circuit, product cooling system with the control circuit being a cooling system control circuit, a product delivery control system with the control circuit being a product delivery control circuit, a temperature control system with a temperature control circuit, or other components.

The user interface 216 can allow a user to interact with the system 200 and receive information through the system. In some instances, the user interface 216 includes a display 222 and/or one or more user inputs 224, such as a buttons, touch screen, track ball, keyboard, mouse, etc., which can be part of or wired or wirelessly coupled with the system 200. Typically, the system 200 further includes one or more communication interfaces, ports, transceivers 220 and the like allowing the system 200 to communicate over a communication bus, a distributed computer and/or communication network 120 (e.g., a local area network (LAN), the Internet, wide area network (WAN), etc.), communication link 218, other networks or communication channels with other devices and/or other such communications or combinations thereof. Further the transceiver 220 can be configured for wired, wireless, optical, fiber optical cable, satellite, or other such communication configurations or combinations of two or more of such communications. Some embodiments include one or more input/output (I/O) ports 234 that allow one or more devices to couple with the system 200. The I/O ports can be substantially any relevant port or combinations of ports, such as but not limited to USB, Ethernet, or other such ports.

The system 200 comprises an example of a control and/or processor-based system with the control circuit 212. Again, the control circuit 212 can be implemented through one or more processors, controllers, central processing units, logic, software and the like. Further, in some implementations the control circuit 212 may provide multiprocessor functionality.

The memory 214, which can be accessed by the control circuit 212, typically includes one or more processor readable and/or computer readable media accessed by at least the control circuit 212, and can include volatile and/or nonvolatile media, such as RAM, ROM, EEPROM, flash memory and/or other memory technology. Further, the memory 214 is shown as internal to the control system 210; however, the memory 214 can be internal, external or a combination of internal and external memory. Similarly, some or all of the memory 214 can be internal, external or a combination of internal and external memory of the control circuit 212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory. The memory 214 can store code, software, executables, scripts, data, content, lists, programming, programs, log or history data, user information and the like. While FIG. 2 illustrates the various components being coupled together via a bus, it is understood that the various components may actually be coupled to the control circuit and/or one or more other components directly.

Some embodiments include the I/O interface 234 that allows wired and/or wireless communication coupling of to external components, such as with one or more product cooling systems 102-104, temperature control selection system 106, delivery vehicles 108, inventory systems 110, customer profile system 112, delivery control system 114, databases 116, and other such devices or systems. Typically, the I/O interface provides wired communication and/or wireless communication e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some implementations, the system 200 includes one or more sensors 226 that can communicate sensor data to the control circuit 212 and/or other systems. The sensors can include one or more temperature sensors, humidity sensors, inertial sensors, wind speed sensors, acceleration sensors, velocity sensors, weight sensor systems, dimensions sensor systems, product identifying sensor systems (e.g., RFID tag readers, bar code scanners, cameras and text capture systems, etc.), other such sensors, or combination of two or more of such sensors. The sensors may communicate wired or wirelessly over the communication link 218, the distributed computer and/or communication network 120, or the like. Further, the sensors 226 are illustrated directly coupled with the control circuit 212 via the communication link 218; however, one or more sensors may be internal, external or a combination of internal and external, other networks or communication channels with other devices and/or other such communications or combinations thereof. For example, in some applications one or more temperature sensors may be positioned within a product cavity of a cooling system, adjacent to or as part of a product holder, incorporated into insulation, external to a housing of a cooling system, other such locations, or combination of two or more of such locations. Additionally or alternatively, one or more sensors and/or sensor systems may be cooperated with and/or positioned as part of or adjacent to a conveyor system that transports products in preparation for delivery, as part of a transport system (e.g., forklift, pallet jack, etc.), and/or other such systems.

As described above, some embodiments include the temperature control selection system 106 that evaluates multiple parameters to select one or more product temperature control systems, from multiple different types of temperature control systems, to be used while delivering one or more products. The temperature control systems can comprise one or more cryogenic substance cooling systems with cryogenic cooling system control circuit, evaporative temperature control systems with an evaporative control system control circuit, aerosol temperature control systems with an aerosol control system control circuit, temperature pack cooling systems, cooling sustaining bag systems, heat pack temperature systems, other temperature control systems, or combination of two or more of such systems. In some embodiments, the temperature control selection system 106 further takes into consideration expected rates of change in temperature and/or expected heat transfer of the one or more products, applied cryogenic substance, insulation, insulation rating or thermal resistance rating, and the like. In some embodiments, the rate of change of temperature is calculated based on a formula for each flow (e.g., ΔQ/Δt=−K×A×ΔT/x, where ΔQ/Δt is the rate of heat flow; −K is the thermal conductivity factor; A is the surface area; ΔT is the change in temperature and x is the thickness of the material).

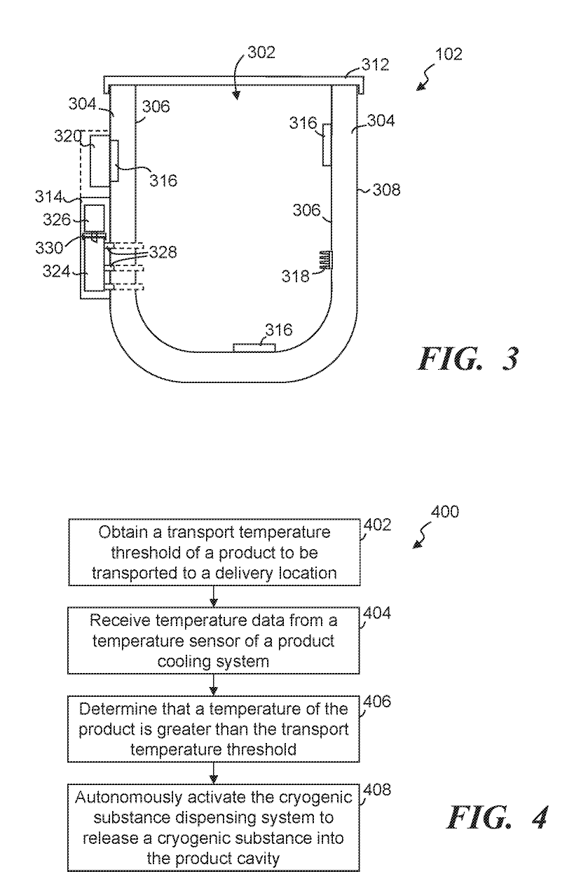

FIG. 3 illustrates a simplified cross-sectional view of an exemplary cryogenic substance cooling system 102, in accordance with some embodiments. The cryogenic substance cooling system 102 includes a product cavity 302 that supports and/or receives one or more products while the one or more products are transported by a delivery vehicle to a delivery location. The cryogenic substance cooling system 102 is typically separate from and removable from the delivery vehicle. The size of cryogenic substance cooling systems 102 can vary, but often are configured to hold a relatively small number of products, such as products that collectively have a volume of less than three cubic feet, typically less than two cubic feet, and often less than one cubit foot. Depending on the size of the product, often the cooling system is capable of only receiving a single product. In some embodiments, the cooling system is selected with dimensions that are only marginally larger than the one or more products being received by the cooling system. Further, the cryogenic substance cooling system may have multiple different sizes, with a particular cooling system being selected based on the size or volume of one or more products intended to be placed into the product cavity. For example, in some applications, the cryogenic substance cooling system adds less than 15% to a total volume of the one or more products (and their packaging) being received, while in some instances is sized such that it adds 10% or less to a volume of the one or more products being received by the cooling system. Although not shown, some embodiments include a lid 312 to close the product cavity. The lid may be part of the exterior and/or interior wall or a separate piece that separates from the product cavity.

Further, the cryogenic substance cooling system 102 includes one or more cryogenic substance dispensing systems 314 that are cooperated with the product cavity 302 and configured to inject a cryogenic substance (e.g., helium, hydrogen, neon, nitrogen, fluorine, argon, methane, oxygen, and air, Freon, hydrogen sulfide, and other such) into the product cavity and/or into one or more cryogenic cavities 304 formed about the product cavity defined between an interior barrier or wall 306 and an exterior barrier or wall 308. In some implementations, the interior and/or exterior walls are rigid, while in other implementations one or both of the interior and exterior walls may be flexible. For example, the interior and exterior walls may, in some embodiments, be formed from a plastic, wax coated paper, or other materials. The interior wall is typically moisture resistant and/or water proof. In the bag configuration, portions of the interior and/or exterior wall may be rolled and/or folded over to close the product cavity. Some embodiments may include one or more heat sinks 318 in the cryogenic cavity, in the product cavity and/or extending to an exterior of the system. One or more dispensers may be positioned to release the cryogenic substance to contact one or more heat sinks 318, which may be in contact with one or more products (e.g., part of the packaging or in contact with packaging of the product) and/or extending from the product cavity. The activation of the cryogenic substance can typically be implemented with relatively low power usage.

The cryogenic substance cooling system further includes one or more temperature sensors 316 and/or other sensors, and a temperature control circuit or system 320 that couples with at least one sensor. The temperature control circuit 320 can part of the cryogenic substance dispensing system 314 or coupled with the cryogenic substance dispensing system and providing at least some control over the cryogenic substance dispensing system. At least one of the temperature sensors 316 is positioned to detect in real time temperature data corresponding to a temperature of one or more products within the cryogenic substance cooling system while the one or more products are in transit to be delivered to a delivery location. In some instances, a temperature sensor may be positioned in contact with a product within the product cavity 302. Additionally or alternatively, one or more temperature sensors may be positioned at one or more locations within the product cavity. Some embodiments include one or more temperature sensors that can detect temperatures outside of the cooling system. In some embodiments, one or more other types of sensors may be included, such as but not limited to one or more humidity sensors, wet bulb temperature sensor, inertia sensors, orientation sensors (e.g., tilt, roll, pitch, yaw, etc.), airflow sensors, other such sensors, or combination of two or more of such sensors. The sensors are in wired or wireless communication with the temperature control circuit 320 and provide sensor data to the temperature control circuit.

The temperature control circuit 320 couples with and receives temperature data from the one or more temperature sensors and/or receive other senor data from one or more other sensor while the one or more products are in the product cavity and/or at least while the one or more products are in transit to a delivery location. Based on current temperature data the temperature control circuit can determine or identify when a temperature of the one or more products is greater than one or more transport temperature thresholds. The transport temperature threshold may be specific to a particular product and typically varies between products. Further, the transport temperature threshold may be limited to while the product is in transit, while one or more other temperature thresholds may be relevant to the product while the product is at a retail facility or other storage location. For example, for some products that are kept cold a transport temperature threshold may be greater than a storage temperature threshold (e.g., ice cream may have a transport temperature threshold that allows a slow melting of the ice cream, while the storage temperature threshold maintains the ice cream in a frozen state). Further, some transport temperature thresholds may further be associated with a time threshold. For example, some products may have multiple transport temperature thresholds with a first transport temperature threshold being less than a second transport temperature threshold, such that the product can exceed the first temperature threshold for a threshold period of time while remaining below the second temperature threshold.

In some embodiments, the temperature control circuit further couples with and/or includes the cryogenic substance dispensing system 314. Based on the temperature data and/or the relationship of temperature data relative to one or more transport temperature thresholds, the temperature control circuit can autonomously activate the cryogenic substance dispensing system 314 to release cryogenic substance into the product cavity 302 and/or the cryogenic cavity 304 while the cryogenic substance cooling system and one or more products are transported by a delivery vehicle. The temperature control circuit can, in some applications, determine an amount of cryogenic substance to be released and/or a rate of release based on the relationship of the determined product temperature and/or the sensed temperature relative to the one or more transport temperature thresholds, the number of products, the volume of the product cavity, expected remaining duration of transit, and/or other such factors.

The cryogenic substance dispensing system, in some applications, includes one or more cryogenic substance reservoirs 324 that store one or more types of cryogenic substances. Further, in some embodiments, the cryogenic substance dispensing system includes a control circuit and/or actuator 326, which may comprise a valve, plunger, puncture pin, compressed substance, or other such actuator that injects cryogenic substance into the cryogenic cavity and/or product cavity. One or more dispenser 328 are cooperated with the reservoir 324 and/or actuator 326. The dispenser is positioned to disperse the cryogenic substance into the product cavity and/or cryogenic cavity. In some instances, multiple dispensers 328 are distributed around the cryogenic cavity and/or product cavity to provide a more equal distribution of the cryogenic substance through the product cavity and/or cryogenic cavity. Some embodiments include different types of dispensers, and the activation of the cryogenic dispensing system can cause cryogenic substance to be dispersed through one or more types of dispensers. The types of dispensers may depend on the product(s) being delivered, the cryogenic substance, the cooling effect being implemented, and the like. For example, one or more dispensers may spray the cryogenic substance, one or more dispensers may generate an aerosol, one or more dispensers may generate a fog, other types of dispensers, or combination of two or more types of dispensers. Again, the temperature control circuit activates the cryogenic substance dispensing system to increase the quantity of cryogenic substance in the product cavity and/or cryogenic cavity.

In some embodiments, insulation, absorbent materials, heat sink and/or other structure may be positioned within the cryogenic cavity and/or the product cavity. The insulation in part insulates the product cavity from an external environment and in some instances is positioned such that the cryogenic substance is sprayed or otherwise dispensed onto the insulation to enable temperature change and/or maintain temperature within the product cavity. The insulation may further assist in a more equal distribution of the cryogenic substance through the cryogenic cavity and/or product cavity. The insulation can be substantially any material that can provide insulation and in some instances that at least partially absorbs and/or wicks the cryogenic substance. For example, the insulation may include a fibrous material that provides a relatively large surface area and/or allows airflow through the fibrous material. Further, in some implementations one or more evaporative openings or holes may be formed in the exterior wall 308, interior wall 306, and/or the lid. The evaporative openings can be configured to expose the dispersed cryogenic substance to additional airflow and/or an exterior environment to affect an evaporation rate of the cryogenic substance and/or other substances. In some instances, evaporative holes on the external wall are incorporated into a limited area allowing control of airflow into and/or across these holes based on an orientation of the cryogenic substance cooling system 102 while being transported. Some embodiments may include flared fins, flaps or the like that are formed adjacent one or more of the evaporative openings to allow for additional control of airflow relative to the evaporative openings.

In some implementations, the cryogenic substance dispensing system 314 is configured to direct the cryogenic substance directly onto the product or products in the product cavity 302. Typically, the cryogenic substance dispensing system includes one or more reservoirs that are configured to hold one or more cryogenic substances. In some applications, the actuator 326 cooperates with and releasably seals the reservoir. The one or more dispensers 328 are cooperated with the reservoir (e.g., through one or more conduits, tubes, etc.) and may be positioned to dispense the cryogenic substance directly onto a packaging of one or more products. The direct application of the cryogenic substance onto the product is distinguished from the cryogenic substance being dispersed as a cloud generally into the product cavity, and intentionally directing the cryogenic substance away from a product (e.g., directing the cryogenic substance at an interior wall 306, the lid 312, into the cryogenic cavity 304, etc.). Alternatively, directing the cryogenic substance directly at a product intends that the cryogenic substance is to at least partially coat an area of the product and typically a packaging of the product. In some embodiments, the product cooling system and/or the temperature control selection system identifies the packaging of the product and determines whether such packaging can be subjected to cryogenic substance being directly applied. For example, a database may be accessed to identify a type of packaging and determining whether that packaging can withstand cryogenic substance being directly applied. As a further example, packaging made of or include standard glass, some plastics, rubber, carbon steel, and other materials may become brittle when exposed to cryogenic materials, and as such the system may restrict or prevent direct application of cryogenic substances directly onto at least those portions of the package that are expected to become brittle as a result of direct application. Other materials may allow direct application of the cryogenic material, such as paper, cardboard, wax-covered cardboard, wax-covered paper, some glasses, aluminum, and other materials.

Further, the temperature control circuit 320, delivery control system 114, inventory system 110 or other component typically identifies a type of packaging of the one or more products and/or whether the product has packaging. Based at least in part on the packaging and/or product, the temperature control circuit (or other component), prior to dispersing the cryogenic substance, identifies and/or is notified that the cryogenic substance can be directly applied to the packaging or product without adversely affecting the product. Often this information is maintained in a product database and/or by the inventory system. For example, in some instances, the application of the cryogenic substance directly onto the packaging may cause a portion of the product to freeze, and/or in some instances rapidly drop in temperature. Some products may adversely be affected by such localized freezing or change in temperature, while other products are not adversely affected (e.g., taste is not altered, intended consistency readily returns upon unfreezing or returns to within a threshold of that intended consistency, does not alter a shelf life of the product, other such aspects, or combination of two or more of such aspects). Other factors may also be considered in determining whether the cryogenic substance can be dispersed directly onto the packaging.

In other instances, an insulation, material or the like can be included in the product cavity and/or positioned about the product. The cryogenic substance may be instead directed directly at the insulation or material. For example, the cryogenic substance may cause a frozen buildup on the material (e.g., forming dry ice).

Again, the cryogenic substance cooling system includes one or more reservoirs 324 that store one or more cryogenic substances. In some embodiments, one or more of the reservoirs may removable and/or refillable. Further, one or more reservoirs may include a cartridge that is readily replaceable and/or refillable. The cryogenic substance dispensing system can further include a reservoir release coupler 330 that is configured to temporarily receive and secure the replaceable cartridge. For example, the replaceable cartridge may be easily screwed on, strapped on, snap-fitted, or the like to cooperate with a valve, be sealed with and punctured by a puncture pin, or other such methods of coupling. Similarly, the cartridge is often a relatively small cartridge that often has a weight that is only a fraction of the weight of the cooling system. For example, in some instances, the cartridge may comprise less than 20% of the weight of the cooling system, and often less than 5% of the weight of the cooling system,

Some embodiments, in dispensing the cryogenic substance, may additionally or alternatively dispense the cryogenic substance to generate a fog within the product cavity 302 and/or the cryogenic cavity 304. The temperature control circuit 320 may activate the release of cryogenic substance through fog dispensers and/or a separate fogger controller may control the release of a fog of cryogenic substance. The fog may be employed in instances where the cryogenic substance should not be dispensed (e.g., sprayed) directly onto a product in the product cavity. In some embodiments, the cryogenic fog may be used to reduce temperature within the product cavity and/or as part of an insulation to slow temperature changes within the product cavity. The temperature control circuit 320 may determine based on the current temperature data that the temperature of a product is less than the first transport temperature threshold and greater than a second transport temperature threshold, and autonomously activate the cryogenic substance dispensing system to release the cryogenic substance into the product cavity inducing a fog within the product cavity and controlling an environmental temperature within the product cavity while the first product is transported by the delivery vehicle. In some instances, the release of the fog of the cryogenic substance may be used as a secondary cooling. As such the cryogenic substance dispensing system 314 can disperse a cryogenic substance directly onto one or more products, and/or additionally disperse the same or a different cryogenic substance as a cloud.

In some embodiments multiple different cooling systems are used. The cryogenic system may be used as in cooperation with one or more other cooling systems, and be used as a primary cooling system or a secondary or back-up cooling system. For example, in some applications the product cooling system comprises a primary cooling system that is distinct from the cryogenic substance dispensing system 314. The primary cooling system can be implemented in attempts to maintain the temperature of one or more products below a first transport temperature threshold. The temperature control circuit may activate the cryogenic substance dispensing system when the primary cooling system is incapable of maintaining the temperature of the one or more products below the first transport temperature threshold. Additionally or alternatively, the temperature control circuit can be configured to identify that the temperature of a product is to be reduced below a first transport temperature threshold within a threshold period of time, and may activate the cryogenic substance dispensing system to release the cryogenic substance to reduce the temperature of the product to below the first transport temperature threshold within the threshold period of time. As such, the cryogenic substance cooling system may, at least in part, provide a rapid cooling of one or more products.

Some embodiments include two or more cryogenic substance reservoirs 324, and at least two of those reservoirs can include different types of cryogenic substances. A primary reservoir may be included that can store a first or primary cryogenic substance that has a first cooling rate and/or evaporation rate. A secondary reservoir can store a secondary cryogenic substance that has a second cooling rate and/or evaporation rate that is different than the first cooling and/or evaporation rate. For example, the secondary cryogenic substance can have the second cooling rate that is greater or produces cooler temperatures than the first cooling rate such that the secondary cryogenic substance more rapidly reduces the temperature of a product than the first cryogenic substance when both are applied in the same conditions. The multiple different cryogenic substance can provide the temperature control circuit with greater control over the temperature maintained within the product cavity 302 and/or the rate of reducing the temperature within the product cavity. In some instances, for example, the temperature control circuit can identify that a current temperature corresponding to a product and/or the temperature of the product in the product cavity is greater than a rapid cool transport temperature threshold, which may be different that a transport temperature threshold. When the temperature control circuit detects that temperature being greater than the rapid cool transport temperature threshold the temperature control circuit can activate the dispensing system (or a secondary dispensing system associated with the secondary reservoir) to inject the secondary cryogenic substance into the product cavity or cryogenic cavity. With the greater cooling rate, the secondary cryogenic substance is expected to provide a more rapid temperature reduction within the product cavity that the first cryogenic substance would. Similarly, the two or more different cryogenic substance can cooperatively be used to achieve a desired temperature and/or maintain a temperature within one or more thresholds do to the variations in concentrations of the two or more cryogenic substance used.

The temperature control selection system 106 can select a type of temperature control and/or cooling system from multiple different types of temperature control and/or cooling systems. For example, the temperature control selection system may consider the cryogenic substance cooling system 102, an evaporative product cooling system, a temperature pack product cooling system, an aerosol product cooling system, a cooled sustaining container product cooling system, other such temperature control systems, or systems that include two or more temperature control systems, such as two or more of the above described product cooling systems. In some embodiments, the temperature control selection system considers a type or method of transport and delivery. For example, the method of transport may be through one or more methods such as, but not limited to, a delivery truck, a delivery van, a delivery car, an unmanned ground or land-based vehicle (UGV), an unmanned aircraft system (UAS), other such delivery methods, or combination of such delivery methods. Other cooling systems are described in U.S. Application Nos. 62/338,246 filed May 18, 2016 and entitled TEMPERATURE PACK COOLING SYSTEMS AND METHODS OF CONTROLLING PRODUCT TEMPERATURES DURING DELIVERY (137872); 62/338,224 filed May 18, 2016 entitled EVAPORATIVE COOLING SYSTEMS AND METHODS OF CONTROLLING PRODUCT TEMPERATURES DURING DELIVERY (137875); 62/338,290 filed May 18, 2016 entitled SYSTEMS AND METHODS OF CONTROLLING PRODUCT TEMPERATURES DURING DELIVERY (137876); 62/345,443 filed Jun. 3, 2016 entitled TEMPERATURE CONTROL SYSTEMS USING TEMPERATURE SUSTAINING BAGS AND METHODS OF CONTROLLING PRODUCT TEMPERATURES DURING DELIVERY (138251); 62/403,909 filed Oct. 4, 2016 entitled SYSTEMS AND METHODS UTILIZING NANOTECHNOLOGY INSULATION MATERIALS IN LIMITING TEMPERATURE CHANGES DURING PRODUCT DELIVERY (137874); 62/350,515 filed Jun. 16, 2016 entitled SYSTEMS AND METHODS OF CONTROLLING PRODUCT TEMPERATURES DURING DELIVERY (138259); and 62/367,376 filed Jul. 27, 2016 entitled SYSTEMS AND METHODS FOR DELIVERING PERISHABLE ITEMS (138262); all of which are incorporated herein by reference in their entirety.

Some temperature control systems may not be suitable for sonic delivery methods, some temperature control systems may be more effective with some methods of delivery, and/or some temperature control systems may be more readily implemented with some delivery methods. Accordingly, the temperature control selection system 106 may identify a scheduled method of delivering the one or more products, and select the cryogenic substance cooling system as a method of temperature control based in part on the method of delivery. For example, when a method of delivery is through the use of a UAS or UGV, the size and/or weight of the cooling system can make some cooling systems unusable for such delivery methods, while some cooling systems are more advantageous for such delivery methods. Further the use of UAS and UGV deliveries may expose the cooling systems to the environment as the product is transported. As such, the evaporative effects of the cryogenic substance and/or the inclusion of the evaporative openings may be particularly beneficial with such delivery methods because of the exposure to the environment, and in some instances evaporation is enhanced because of the exposure to the wind that is at least induced while the UAS or UGV is moving.

Further, the weight of temperature control systems used particularly with UASs, and in some instances with UGVs, can make some cooling systems difficult to use. In many instances, the cryogenic substance cooling system 102 can be implemented to have a relatively light weight (e.g., interior and exterior walls being formed from light weight Styrofoam, plastic, paper, cardboard, other such materials or combination of two or more of such materials). Similarly, the use of the cryogenic substance can allow the one or more reservoirs to be relatively small (e.g., in some embodiments intended for use with UASs, less than 1 pound, and often less than five ounces). Accordingly, the cryogenic substance cooling system can be a desired method of cooling with some delivery methods. Such delivery parameters corresponding to the method of delivery can be considered by the temperature control selection system, which can select the cryogenic substance system for some methods of transport and delivery. Further, in some implementations, the temperature control selection system may select two or more of the temperature control systems to be cooperatively utilized during the delivery, and/or one to be used as a primary cooling system with one or more to be utilized as secondary cooling method and/or backup cooling method. Further, multiple methods of delivery may be used (e.g., delivery truck and a UAS). Accordingly, multiple temperature control systems may be selected. The temperature control selection system, in some applications, is configured to obtain a temperature threshold of a product, identify a method of transporting the product by the delivery vehicle to the delivery location, and select from multiple different types of temperature control systems the product cooling system with the cryogenic substance dispensing system as a function of the method of transport. In some embodiments, the temperature control selection system may further select a type, size and/or shape of the cryogenic system. This selection may be based on the product(s), the delivery vehicle, product temperature threshold, exterior conditions and the like. For example, when the delivery vehicle is a UAS, the system may be selected with an aerodynamically enhanced shape and a reduced weight. In some instances the container is a closed insulated bag with the cryogenic substance dispensing system 314, while in other instances it may be a Styrofoam container (e.g., when weight is a factor).

In some embodiments, the cryogenic substance cooling system is configured for use in relatively short duration transports. For example, the cryogenic substance cooling systems may be limited to transport times that correspond to approximately the flight time of a UAS to a delivery location, and typically with a margin of error, such as +50% of the flight time. Often, the quantity of cryogenic substance to maintain desired temperatures is relatively small, and thus the weight of the system may be relatively light compared with other systems allowing the cryogenic substance cooling system to be advantageous for LAS delivery, while the weight can be further limited because once delivery occurs the temperature typically no longer has to be maintained. As further examples, the cryogenic substance cooling systems may be limited to transport times (which can include time to stage the product and cooling system, load the delivery vehicle, transport the product, and deliver the product to the customer, and in some instances may include time after delivery before a customer is expected to retrieve the delivery) of less than eight hours, and in some instances restricted to transport times of less than four hours.

Again, in some embodiments the delivery vehicle can be an unmanned aircraft system (UAS). The UAS is configured to secure and lift the cryogenic substance cooling system and the one or more products supported by the cryogenic substance cooling system while the UAS transports the cryogenic substance cooling system and the product by air to the delivery location. The cryogenic substance cooling system limits a temperature change of the product by, at least in part, maintaining a temperature within the product cavity 302.

In some embodiments, the temperature control circuit can further be configured to control an airflow around, across and/or into the evaporative openings to control a rate of evaporation of the one or more cryogenic substances. In some embodiments, the temperature control circuit can determine a desired orientation of the product cooling system and one or more of the evaporative openings relative to a direction of travel and/or a desired velocity while in transit to achieve a desired airflow across and/or through one or more evaporative openings and into or through the cryogenic cavity 304 and/or product cavity 302. The rate of evaporation can be increased or decreased in at least some implantations by adjusting airflow into and/or through the cryogenic cavity and/or product cavity. In some embodiments, the temperature control circuit considers the evaporation rate of the cryogenic substance, and historic data corresponding to changes in evaporation rate and/or temperatures within the product cavity as a function of changes in airflow across and/or into the evaporative openings. The temperature control circuit further has knowledge of the positioning and/or configuration of the evaporative openings and can cause an adjustment in orientation to cause an adjustment in airflow relative to one or more evaporative openings. In some embodiments, the product cooling system 102 may include one or more airflow sensors that can provide airflow data to the temperature control circuit. The temperature control circuit can utilize this airflow data in cooperation with a current orientation, positioning and/or mapping of the evaporative openings and a desired change in evaporation to achieve a desired temperature within the product cavity.

The temperature control circuit, in some instances, can autonomously communicate one or more instructions to cause a modification of the orientation of the product cooling system 102 and/or velocity as the delivery vehicle travels toward the delivery location to modify the airflow through the at least one evaporative opening. For example, when the delivery vehicle is a UAS, the instruction can be communicated to the UAS to cause the UAS to rotate a specified number of degrees relative to a direction of travel, increase or decrease speed, change elevation, etc. Similarly, when the delivery vehicle is a UGV, the instruction can cause the UGV to change directions and/or speed for a period of time and/or activate a mechanism on the UGV to rotate the product cooling system 102.

Further, some embodiments additionally or alternatively take advantage of ambient conditions to implement evaporative cooling and/or enhance the evaporative cooling. In some instances, a UAS delivery vehicle may fly through a cloud that deposits moisture on at least the exterior wall 308. This exterior moisture evaporates to enhance the cooling and/or limit a change in temperature within the cryogenic cavity 304 and product cavity 302. The continued flight of the UAS delivery vehicle can be controlled to further adjust a rate of evaporation of the moisture that adheres to the exterior walls. For example, the temperature control circuit 320 can receive temperature sensor data and detect a change in temperature of the exterior wall and/or a change in the rate of change of temperature within the cryogenic cavity to identify an evaporative effect on the exterior wall. Additionally or alternatively, one or more moisture sensors may be positioned to detect exterior moisture. The rate of evaporation of the exterior moisture in part can be controlled based on a speed of the UAS delivery vehicle, an orientation of the cryogenic substance cooling systems 102 while being transported, rate of injection of cryogenic substance within the cryogenic cavity, and the like.

In some embodiments, the temperature control circuit 320 may receive an indication of exterior moisture and cause a change in orientation of the cryogenic substance cooling systems 102 while the exterior moisture is present to enhance a distribution of the exterior moisture across a larger area of the exterior wall and/or all of the exterior wall. Similarly, one or more evaporative openings may be adjusted to reduce evaporation from the cryogenic cavity 304 and/or product cavity as a result of the exterior moisture and expected enhanced exterior evaporation. In some implementations, the UAS delivery vehicle may be routed with attempts to interact with clouds, fog or other conditions to take advantage of exterior moisture and evaporative effects, which can save cryogenic substance, battery power, and the like. For example, it may be identified through one or more remote sensors, previous UAVs, and/or weather data that clouds are present at a determined altitude, and the UAS delivery vehicle can be directed by the temperature control circuit and/or a central system to fly at an altitude that is expected to allow the product cooling system to interact with the exterior moisture. The temperature control circuit 320 and/or a central system can evaluate current conditions relative to historic conditions in identifying when it is expected that sufficient external moisture sources are to be available along a delivery route. Further, in sonic implementations the delivery route may be modified to allow the cryogenic substance cooling system to interact with expected exterior moisture sources,

Although FIG. 3 shows a cryogenic substance cooling system with a single product cavity 302, other embodiments may include multiple different product cavities. Similarly, although FIG. 3 shows the cryogenic substance cooling system with a single cryogenic cavity, other embodiments may include multiple different cryogenic cavities. Further, different cryogenic substances may be used in different product cavities and/or cryogenic cavities, and thus provide different rates of heat transfer relative to the one or more product cavities.

FIG. 4 illustrates a simplified flow diagram of an exemplary process 400 of limiting temperature changes of a product during transit, in accordance with some embodiments. In step 402, a transport temperature threshold is obtained for a product to be transported to a delivery location by a delivery vehicle. Again, one or more temperature thresholds (and in some instances corresponding duration thresholds) may be associated with a product. The temperature threshold may be a minimum temperature, a maximum temperature, a desired transport temperature, a temperature associated with a corresponding duration of time, or the like.

In step 404, temperature data is received while the product is being transported to the delivery location by the delivery vehicle. In some embodiments, the temperature data is received from one or more temperature sensors of the cryogenic substance cooling system 102. Further, in some applications, the cryogenic substance cooling system is separate from and removable from the delivery vehicle, and supports at least the product within the product cavity 302 while in transit to the delivery location. In some implementations, the cryogenic substance cooling system and/or a size of a cryogenic substance cooling system is selected at least in part based on a volume, shape and/or dimensions of the product cavity relative to the product to be placed into the product cavity. For example, the selected cryogenic substance cooling system selected may have dimensions that are similar to the product being delivered and adds less than 20% to the volume of space occupied by the product, and in some instances adds less than 10%.

In step 406, it is determined based on current temperature data that a temperature of the product within the product cavity is greater than the transport temperature threshold associated with the product. In step 408, the cryogenic substance dispensing system is autonomously activated while the product is transported by the delivery vehicle. The activation of the dispensing system causes one or more types of cryogenic substances to be released into the product cavity and/or the cryogenic cavity of the product cooling system while transporting the product.

In some implementations, the activation of the cryogenic substance dispensing system includes activating an actuator to unseal a reservoir storing the cryogenic substance and causing the cryogenic substance to be dispensed from a dispenser and directly onto a packaging of one or more products in the product cavity. The cryogenic reservoir may be configured to be readily replaced. Some embodiments temporarily receive and secure a replaceable reservoir with the product cooling system. For example, the reservoir can comprise a replaceable cartridge that is temporarily coupled with a reservoir release coupler 330 of the cryogenic substance dispensing system.

In some instances, the cryogenic dispensing system is activated to release cryogenic substance directly onto one or more products. Some embodiments identify that the packaging of one or more products comprise a first type of packaging. It can be further identified, based in part on the packaging comprising the first type of packaging, that the cryogenic substance can be directly applied to the packaging without adversely affecting the first product. In some applications it can be determined, based on the current temperature data, that the temperature of the first product is less than the first transport temperature threshold and greater than a second transport temperature threshold. The cryogenic substance dispensing system can autonomously activate to release the cryogenic substance into the product cavity and/or the cryogenic cavity inducing a fog within the product cavity and/or the cryogenic cavity, and controlling an environmental temperature within the product cavity while the product is transported by the delivery vehicle.

In some embodiments, the cryogenic substance dispensing system and/or the cryogenic substance cooling system is one of multiple cooling systems utilized, and may be a primary cooling system or a secondary or backup cooling system. For example, some embodiments detect that a primary cooling system, which is distinct from the cryogenic substance dispensing system, and that attempts to maintain the temperature of the product below the transport temperature threshold, is incapable of maintaining the temperature of the product below the transport temperature threshold. The cryogenic substance dispensing system can be activated based on the primary cooling system being incapable of maintaining the temperature of the product below the transport temperature threshold. Additionally or alternatively, some embodiments identify that the temperature of the product is to be reduced below the transport temperature threshold within a threshold period of time, and the cryogenic substance dispensing system can be activated to release the cryogenic substance to reduce the temperature of the product to a temperature that is below the transport temperature threshold within the threshold period of time.

Some embodiments identify a method of transport of the product by the delivery vehicle to the delivery location, and select from multiple different types of temperature control systems the product cooling system with the cryogenic substance dispensing system as a function of the method of transport. As described above, the cryogenic substance cooling system may be used with one or more different types of delivery methods and/or with one or more different types of delivery vehicles, while may not being practical for other types of delivery methods. Further, the cryogenic substance system may be more practical with some methods of transport and/or delivery vehicles than with others. For example, the cryogenic substance cooling system may be implemented through lightweight materials, with a relatively small and light weight cryogenic substance reservoir. As such, the cryogenic substance may be advantageous for UAS and/or some UGVs. Further, some embodiments evaluate the one or more products to be transported and the corresponding one or more temperature thresholds associated with each of those one or more products. The selection of the cryogenic substance cooling system over the multiple other potential cooling systems is typically further dependent on the one or more temperature thresholds, types of products, and/or the transportation parameters. Additionally, in some embodiments, multiple different types and/or configurations of the cryogenic substance cooling system may be available. For example, multiple different sizes of cryogenic substance cooling systems 102 are available and a particular one can be selected based in part on the number of products being transported and the size or volume of the one or more products. For example, some embodiments may provide multiple different sized cryogenic substance cooling systems, and the sized cryogenic substance cooling system may be selected to be the smallest available system that can receive the one or more products and be used to transport the one or more products. In some embodiments, the temperature control selection system 106 and/or other system can obtain an optimum stacking and/or positioning of the multiple products within the one or more product cavities, and instructions can be provided to a worker (e.g., written, illustrations, etc. that can be communicated to a personal device (e.g., smartphone, tablet, etc.), displayed through a computer, communicated as an email or text, or otherwise provided to the worker) to direct the worker in positioning products within the product cavity of the selected cryogenic substance cooling system. Similarly, the system may select one or more cryogenic substances to be used and provide instructions that direct the worker to cooperate one or more types of cryogenic substances, reservoirs and/or cartridges with the selected product cooling system (e.g., attach a cryogenic substance reservoir 324 with a cryogenic substance dispensing system 314).

In some embodiments, systems, apparatuses, methods and processes are provided to limit temperature changes of a product during delivery. Some embodiments provide systems comprising a product cooling system comprising: a product cavity that supports a first product while the first product is transported to a delivery location by a delivery vehicle, wherein the product cooling system is separate from and removable from the delivery vehicle and comprises an insulation about the product cavity; a cryogenic substance dispensing system is cooperated with the product cavity and configured to inject a cryogenic substance into the product cavity; and a temperature sensor positioned to detect in real time temperature data corresponding to a temperature of the first product while the first product is in transit to be delivered to a delivery location; and a temperature control circuit coupled with the temperature sensor and the cryogenic substance dispensing system, wherein the temperature control circuit is configured to receive temperature data from the temperature sensor while the first product is in transit to the delivery location, determine based on current temperature data that a temperature of the first product is greater than a first transport temperature threshold, and autonomously activate the cryogenic substance dispensing system to release the cryogenic substance into the product cavity while the first product is transported by the delivery vehicle.

Further, some embodiments provide methods of limiting temperature changes of a product during transit. Sonic of these methods comprise: obtaining a first transport temperature threshold of a first product to be transported to a delivery location by a delivery vehicle; receiving, while the first product is being transported to the delivery location by the delivery vehicle, temperature data from a temperature sensor of a product cooling system that is separate from and removable from the delivery vehicle and that supports the first product within an insulated product cavity while in transit to the delivery location; determining based on current temperature data that a temperature of the first product is greater than the first transport temperature threshold; and autonomously activating a cryogenic substance dispensing system of the product cooling system to release a cryogenic substance into the product cavity while the first product is transported by the delivery vehicle.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system to limit temperature changes of a product during transit, comprising:
a product cooling system comprising:
a product cavity that supports a first product while the first product is transported to a delivery location by a delivery vehicle, wherein the product cooling system is separate from and removable from the delivery vehicle and comprises an insulation about the product cavity;
a cryogenic substance dispensing system is cooperated with the product cavity and configured to inject a cryogenic substance into the product cavity; and
a temperature sensor positioned to detect in real time temperature data corresponding to a temperature of the first product while the first product is in transit to be delivered to a delivery location; and
a temperature control circuit coupled with the temperature sensor and the cryogenic substance dispensing system, wherein the temperature control circuit is configured to receive temperature data from the temperature sensor while the first product is in transit to the delivery location, determine based on current temperature data that a temperature of the first product is greater than a first transport temperature threshold, and autonomously activate the cryogenic substance dispensing system to release the cryogenic substance into the product cavity while the first product is transported by the delivery vehicle.

2. The system of claim 1, wherein the cryogenic substance dispensing system comprises a reservoir configured to hold the cryogenic substance, an actuator cooperated with and releasably sealing the reservoir, and a dispenser cooperated with the reservoir and positioned to dispense the cryogenic substance directly onto a packaging of the first product.

3. The system of claim 2, wherein the reservoir comprises a replaceable cartridge, and the cryogenic substance dispensing system comprises a reservoir release coupler configured to temporarily receive and secure the replaceable cartridge.

4. The system of claim 2, wherein the temperature control circuit is configured to identify the packaging of the first product comprises a first type of packaging, and identify based in part on the packaging comprising the first type of packaging that the cryogenic substance can be directly applied to the packaging without adversely affecting the first product.

5. The system of claim 2, wherein the temperature control circuit is configured to determine based on the current temperature data that the temperature of the first product is less than the first transport temperature threshold and greater than a second transport temperature threshold, and autonomously activate the cryogenic substance dispensing system to release the cryogenic substance into the product cavity inducing a fog within the product cavity and controlling an environmental temperature within the product cavity while the first product is transported by the delivery vehicle.

6. The system of claim 1, wherein the product cooling system comprises a primary cooling system distinct from the cryogenic substance dispensing system, wherein the primary cooling system is implemented in attempts to maintain the temperature of the first product below the first transport temperature threshold, and wherein the temperature control circuit activates the cryogenic substance dispensing system when the primary cooling system is incapable of maintaining the temperature of the first product below the first transport temperature threshold.

7. The system of claim 1, wherein the temperature control circuit is configured to identify that the temperature of the first product is to be reduced below the first transport temperature threshold within a threshold period of time, and activates the cryogenic substance dispensing system to release the cryogenic substance to reduce the temperature of the first product to below the first transport temperature threshold within the threshold period of time.

8. The system of claim 1, further comprising:
a temperature control selection system configured to obtain the first transport temperature threshold of the first product, identify a method of transport of the first product by the delivery vehicle to the delivery location, and select from multiple different types of temperature control systems the product cooling system with the cryogenic substance dispensing system as a function of the method of transport.

9. A method of limiting temperature changes of a product during transit, comprising:
obtaining a first transport temperature threshold of a first product to be transported to a delivery location by a delivery vehicle;
receiving while the first product is being transported to the delivery location by the delivery vehicle, temperature data from a temperature sensor of a product cooling system that is separate from and removable from the delivery vehicle and that supports the first product within an insulated product cavity while in transit to the delivery location;
determining based on current temperature data that a temperature of the first product is greater than the first transport temperature threshold; and
autonomously activating a cryogenic substance dispensing system of the product cooling system to release a cryogenic substance into the product cavity while the first product is transported by the delivery vehicle.

10. The method of claim 9, wherein the activating the cryogenic substance dispensing system comprises activating an actuator to unseal a reservoir storing the cryogenic substance and causing the cryogenic substance to be dispensed from a dispenser and directly onto a packaging of the first product.

11. The method of claim 10, further comprising:
temporarily receiving and securing a replaceable reservoir with the product cooling system, wherein the reservoir comprises a replaceable cartridge and the temporarily receiving and securing the replaceable reservoir comprises temporarily coupling the replaceable cartridge with a reservoir release coupler of the cryogenic substance dispensing system.

12. The method of claim 10, further comprising:
identifying that the packaging of the first product comprises a first type of packaging; and
identifying based in part on the packaging comprising the first type of packaging that the cryogenic substance can be directly applied to the packaging without adversely affecting the first product.

13. The method of claim 10, further comprising:
determining, based on the current temperature data, that the temperature of the first product is less than the first transport temperature threshold and greater than a second transport temperature threshold; and
autonomously activating the cryogenic substance dispensing system to release the cryogenic substance into the product cavity inducing a fog within the product cavity and controlling an environmental temperature within the product cavity while the first product is transported by the delivery vehicle.

14. The method of claim 9, further comprising:
detecting that a primary cooling system, which is distinct from the cryogenic substance dispensing system and that attempts to maintain the temperature of the first product below the first transport temperature threshold, is incapable of maintaining the temperature of the first product below the first transport temperature threshold; and
wherein the activating the cryogenic substance dispensing system comprises activating the cryogenic substance dispensing system based on the primary cooling system being incapable of maintaining the temperature of the first product below the first transport temperature threshold.

15. The method of claim 9, wherein the activating the cryogenic substance dispensing system comprises:
identifying that the temperature of the first product is to be reduced below the first transport temperature threshold within a threshold period of time, and activating the cryogenic substance dispensing system to release the cryogenic substance to reduce the temperature of the first product to below the first transport temperature threshold within the threshold period of time.

16. The method of claim 9, further comprising:
identifying a method of transport of the first product by the delivery vehicle to the delivery location; and
selecting from multiple different types of temperature control systems the product cooling system with the cryogenic substance dispensing system as a function of the method of transport.
